(19) United States
(12) Patent Application Publication
(10) Pub. No.: US 2005/0254358 A1
(43) Pub. Date: Nov. 17, 2005

(54) Heat radiating structure of a digital camera

(75) Inventor: Kosei Kosako, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/114,174

(22) Filed: Apr. 26, 2005

(30) Foreign Application Priority Data
May 12, 2004 (JP) 2004-142888

(51) Int. Cl. G11B 7/00

(52) U.S. Cl. 369/44.14; 369/44.11

(57) ABSTRACT

A heat radiating structure of a digital camera includes an optical system holder which holds an image-forming optical system; an image pickup device supported by the optical system holder; an outer casing which constitutes an external body of the digital camera which surrounds the optical system holder, the outer casing having a through-hole which communicatively connects the inside of the outer casing with the outside thereof; an external radiating member installed in the through-hole, being made of a material having a thermal conductivity higher than that of the outer casing; a heat radiating plate, one end of which is connected to the image pickup device and another end of which extends into a space between the external radiating member and the optical system holder; and a heat transfer member via which the heat radiating plate and the external radiating member are connected to each other.

### BACKGROUND OF THE INVENTION

1. Field of the Invention

The present invention relates to a heat radiating structure of a digital camera for cooling a solid-state image pickup device provided in the digital camera.

2. Description of the Related Art

In conventional digital still/video cameras (hereinafter referred to simply as digital cameras), the heat generated by a solid-state image pickup device (e.g. a CCD or a CMOS image sensor) serving as an element of an imaging device needs to be dissipated with efficiency to prevent image data, which is output from the imaging device, from including noise caused by the heat generated by the solid-state image pickup device and to prevent the optical accuracy of an optical unit from deteriorating due to an expansion of the optical unit which is caused by the heat generated by the solid-state image pickup device. For instance, many digital cameras are provided with an LCD indicator on the back of the camera body, so that the heat generated by the solid-state image pickup device is difficult to be dissipated rearward.

### SUMMARY OF THE INVENTION

The present invention provides a digital camera which has excellent in heat radiation efficiency for the imaging device, and has less possibility of the heat generated by the solid-state image pickup device of the digital camera exerting adverse influence upon an optical system provided in the digital camera.

According to an aspect of the present invention, a heat radiating structure of a digital camera is provided, including an optical system holder which accommodates and holds an image-forming optical system; an image pickup device supported by the optical system holder at a position on a focal plane of the image-forming optical system; an outer casing which constitutes an external body of the digital camera which surrounds the optical system holder, the outer casing having a through-hole which communicatively connects the inside of the outer casing with the outside of the outer casing; an external radiating member installed in the through-hole, the external radiating member being made of a material having a thermal conductivity higher than a thermal conductivity of a material of the outer casing; a heat radiating plate, one end of which is connected to the image pickup device and another end of which extends into a space between the external radiating member and the optical system holder; and a heat transfer member via which the heat radiating plate and the external radiating member are connected to each other to transfer heat from the heat radiating plate to the external radiating member.

It is desirable for the heat transfer member to be made of an elastic material having a high thermal conductivity.

The heat radiating structure can include an intermediate heat-insulation frame positioned between the optical system holder and the outer casing, wherein the heat radiating plate and the intermediate heat-insulation frame are connected to each other via a heat-insulation spacer.

It is desirable for the outer casing to include a plurality of flat portions positioned to surround an optical axis of the image-forming optical system, and for the digital camera to include a rotatable grip mounted to one of the plurality of flat portions to be rotatable relative the one of the plurality of flat portions. The through-hole, in which the external radiating member is installed, is formed on another of the plurality of flat portions.

It is desirable for the heat radiating plate to be made of metal.

It is desirable for the heat radiating plate to include a first plate portion including the one end of the heat radiating plate, and a second plate portion including the another end of the heat radiating plate, the second plate portion extending toward the front of the digital camera from the first plate portion in the space between the external radiating member and the optical system holder.

It is desirable for the through-hole to be formed as an elongated hole and the external radiating member to be correspondingly formed as an elongated member to be fitted in the elongated hole.

It is desirable for at least a part of the external radiating member to be made of metal.

In an embodiment, a heat radiating structure of a digital camera is provided, including an optical system holder which holds an image-forming optical system, an image pickup device being supported by the optical system holder at a rear end thereof in an optical axis direction; a tubular outer casing which constitutes an external body of the digital camera, the tubular outer casing including a surrounding portion which surrounds the optical system holder, and a rear end portion positioned to face a rear portion of the image pickup device; an intermediate heat-insulation frame provided inside the tubular outer casing between the surrounding portion and the optical system holder; a heat radiating plate, one end of which is connected to the image pickup device, the heat radiating plate extending from a first space between the rear end portion of the tubular outer casing and the image pickup device to a second space between the surrounding portion and the intermediate heat-insulation frame; an external radiating member fixed to the surrounding portion to extend therethrough to face the heat radiating plate and to be exposed to an external portion of the digital camera, the external radiating member being made of a material having a thermal conductivity higher than a thermal conductivity of a material of the tubular outer casing; and a heat transfer member via which the heat radiating plate and the external radiating member are connected to each other to transfer heat from the heat radiating plate to the external radiating member.

According to the present invention, a digital camera which is excellent in heat radiation efficiency of the imaging device, and has less possibility of the heat generated by the solid-state image pickup device of the digital camera exerting an influence upon an optical system provided in the digital camera is achieved.

The present disclosure relates to subject matter contained in Japanese Patent Application No. 2004-142888 (filed on May 12, 2004) which is expressly incorporated herein by reference in its entirety.

### BRIEF DESCRIPTION OF THE DRAWINGS

The present invention will be described below in detail with reference to the accompanying drawings in which:

FIG. 1 is a perspective view of an embodiment of a digital camera having a heat radiating structure according to the present invention;

FIG. 2 is a perspective view of the digital camera shown in FIG. 1, viewed from a different angle;

FIG. 3 is a rear elevational view of the digital camera shown in FIGS. 1 and 2;

FIG. 4 is a side elevational view of the digital camera shown in FIGS. 1 and 2, viewed from the grip side;

FIG. 5 is a side elevational view of the digital camera shown in FIGS. 1 and 2, showing a state in which the grip is rotated to extend rearwards from the camera body;

FIG. 6 is a side elevational view of the digital camera shown in FIGS. 1 and 2, showing a state in which the grip is rotated to extend obliquely downwards from the camera body;

FIG. 7 is a side elevational view of the digital camera shown in FIGS. 1 and 2, showing a state in which the grip is rotated to extend downwards from the camera body;

FIG. 8 is a side elevational view of the digital camera shown in FIGS. 1 and 2, showing a state in which an LCD monitor unit is in an upright position;

FIG. 9 is a view similar to that of FIG. 4 and shows a state in which the LCD monitor unit is reversed from the position shown in FIG. 4;

FIG. 10 is a front view in perspective of the digital camera shown in FIGS. 1 and 2, showing a state in which the LCD monitor unit is in an upright position;

FIG. 11 is a front elevational view of the digital camera shown in FIGS. 1 and 2, showing a state in which the grip is positioned closely to the camera body;

FIG. 12 is a front elevational view of the digital camera shown in FIGS. 1 and 2, showing a state in which the grip is in an extended positioned from the camera body;

FIG. 13 is a front elevational view of internal elements of the digital camera shown in FIGS. 1 and 2, showing internal circuitry of the camera body;

FIG. 14 is a plan view of the internal elements shown in FIG. 13;

FIG. 15 is a side elevational view of the internal elements shown in FIG. 13;

FIG. 16 is a side elevational view of the internal elements shown in FIG. 13, viewed from the side opposite to the side shown in FIG. 15;

FIG. 17 is a cross sectional view taken along XVII-XVII line shown in FIG. 2, showing an internal structure of the digital camera shown in FIGS. 1 and 2 in the vicinity of a CCD image sensor; and

FIG. 18 is a cross sectional view taken along XVIII-XVIII line shown in FIG. 17, showing an internal structure of the digital camera shown in FIGS. 1 and 2 in the vicinity of the CCD image sensor.

### DESCRIPTION OF THE PREFERRED EMBODIMENT

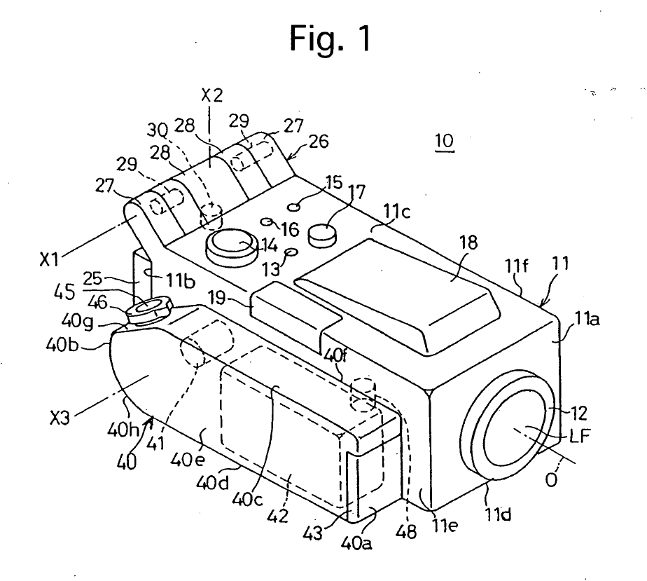

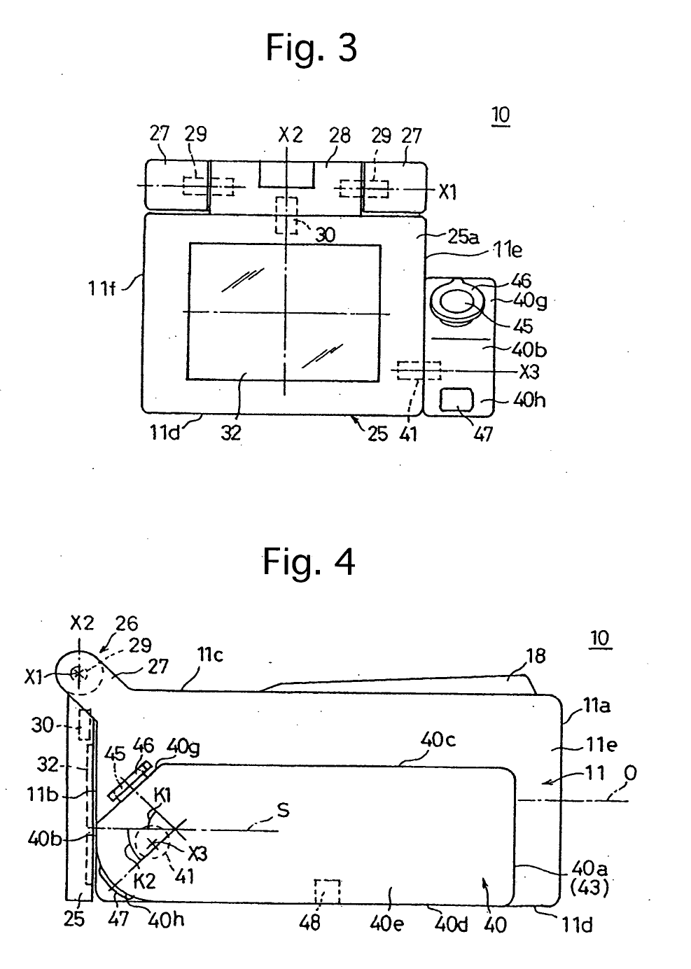

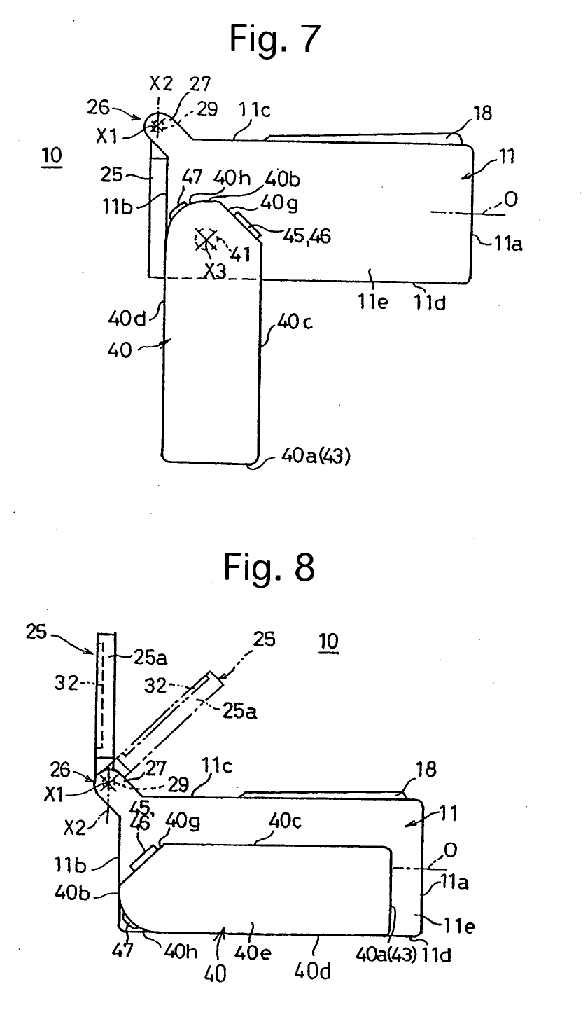

FIGS. 1 through 12 show an embodiment of a digital camera having a heat radiating structure according to the present invention. The digital camera 10 is provided with a camera body (outer casing) 11 including a photographing optical system (image-forming optical system) PY (see FIGS. 14 through 16). The camera body 11 is formed as a substantially rectangular parallelepiped which is elongated along an optical axis O of the photographing optical system PY. The outer surface of the camera body 11 is composed of six surfaces (flat portions): a front end surface 11a, a rear end surface 11b, a top surface 11c, a bottom surface 11d, a right side surface 11e, and a left side surface 11f. The top surface 11c, the bottom surface 11d, the right side surface 11e, and the left side surface 11f connect the front end surface 11a with the rear end surface 11b, and surround the optical axis O. In the present embodiment of the digital camera, the vertical direction and the horizontal direction of FIGS. 3, 11 and 12 correspond to the vertical direction and the horizontal direction of the digital camera 10, respectively. More specifically, the right-hand side of the digital camera 10 with respect to the rear side thereof (as viewed from the right-hand side shown in FIG. 3) is defined as the right-hand side of the digital camera 10, while the left-hand side of the digital camera 10 with respect to the rear side thereof is defined as the left-hand side of the digital camera 10. In addition, a direction parallel to the optical axis O is defined as a forward/rearward direction of the digital camera 10, the front end surface 11a is defined as the front side of the digital camera 10, and the rear end surface 11b is defined as the rear side of the digital camera 10.

The digital camera 10 is provided in the camera body 11 with a frontmost lens group LF of the photographing optical system PY which is exposed to the outside of the camera body 10 from the front end surface 11a. The frontmost lens group LF can be a lens group consisting of a single lens element or a plurality of lens elements (see FIGS. 14 through 16). The camera body 11 is provided, on the front end surface 11a around the frontmost lens group LF, with a filter mounting screw 12 by which an accessory such as a filter can be attached to the front of the frontmost lens group LF. The photographing optical system PY of the digital camera 10, that is provided inside the camera body 11, is a zoom lens optical system having more than one lens group in addition to the frontmost lens group LF. Specifically, the photographing optical system PY is an internal-focusing/zooming optical system in which the focus or the focal length is altered by moving elements internally within the lens barrel (i.e., the external lens barrel is not extended or retracted). Accordingly, the frontmost lens group LF does not move forward from the position thereof shown in the drawings.

The digital camera 10 is provided, on the top surface 11c of the camera body 11 in an area thereon close to the rear end surface 11b, with a mode select dial 14 and various manual operational buttons such as a power button 13, a playback button 15, a menu button 16 and a multi-direction button 17. The power button 13 serves as a manual operational member for turning ON and OFF a main switch of the digital camera 10. The mode select dial 14 serves as a manual operational member for selecting a desired photographing mode from among different photographing modes. The playback button 15 serves as a manual operational member for reproducing stored images on a liquid crystal display (LCD) portion 32. Upon an operation of the menu button 16, the digital camera 10 enters a setting changing mode in which various settings on the digital camera 10 can be changed and set by operating the multi-direction button 17. The multi-direction button 17 is also used to switch playback images to be displayed on the LCD portion 32. Various settings which can be changed by operating the menu button 16 include the settings of storing image size, image quality, white balance and sensitivity, but are not limited solely to theses specific settings. The multi-direction button 17 is made of a momentary switch which can be operated to move in different directions. For instance, the multi-direction button 17 can be operated in biaxial directions orthogonal to each other (four directions: forward, rearward, right and left), and also in a press-down direction at an intersection of the aforementioned biaxial directions, i.e., at the center thereof. The digital camera 10 is provided, on top of the camera body 11, in front of the various manual operational buttons, with a pop-up flash 18. The pop-up flash 18 can be switched between a pop-up position in which a light emitting portion of the pop-up flash 18 projects upwards from the top surface 11c of the camera body 11, and a retracted position in which the light emitting portion of the pop-up flash 18 is retracted into the top surface 11c of the camera body 11. In each of FIGS. 1 through 12, the pop-up flash 18 is in the retracted position, and accordingly, the light emitting portion of the pop-up flash 18 is not shown. The camera body 11 is provided in the vicinity of the ridge (border) between the upper surface 11c and the right side surface 11e with a card slot lid 19 for covering a card slot (not shown) formed on the camera body 11. This card slot is accessible from the outside of the camera body 11 by opening the card slot lid 19. In a state in which the cart slot lid 19 is open, a memory card in which image data are stored can be inserted and removed into and from the memory card slot.

The digital camera 10 is provided, on the left side surface 11f of the camera body 11 at regular intervals in the optical axis direction, with a flash mode s-elect button 20, a drive mode select button 21 and a focus mode select button 22. The flash mode select button 20, the drive mode select button 21 and the focus mode select button 22 are positioned in substantially the same range, in the optical axis direction, as the aforementioned various manual operational members (13 through 17) in the optical axis direction. The flash mode select button 20 serves as a manual operational member for controlling the operation of the light emitting portion of the pop-up flash 18. By operating the flash mode select button 20, a desired flash mode can be selected from among different flash modes such as auto flash mode, compulsory flash mode, suppressed flash mode and red-eye reduction mode. The drive mode select button 21 serves as a manual operational button for selecting a drive mode at a shutter release from among different drive modes such as normal drive mode (single-frame mode), multi-frame consecutive photographing mode, self-timer photographing mode and auto-bracketing photographing mode. The focus mode select button 22 serves as a manual operational member for selecting a focus mode from among different focus modes such as normal auto focus mode, macro (close-up) photographing mode, infinity photographing mode and manual focus mode. The digital camera 10 is provided, on the left side surface 11f of the camera body 11 slightly in front of the flash select button 20, with speaker slits 23, and is further provided, on the camera body 11 below the speaker slits 23, with an external connector cover 24. The external connector cover 24 can be opened and closed (or detached and attached) with respect to the left side surface 11f of the camera body 11.

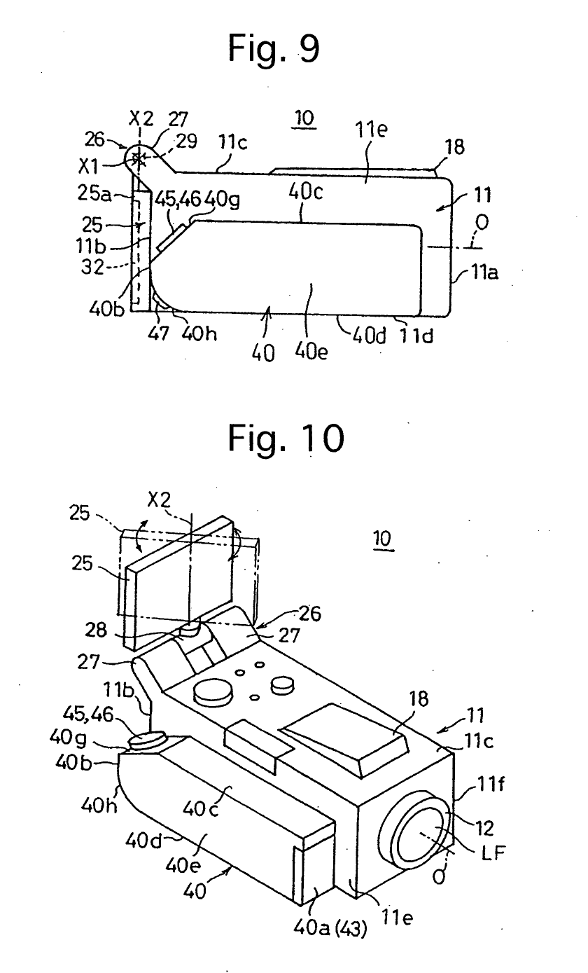

The digital camera 10 is provided at the back of the camera body 11 (on the rear end surface 11b) with an LCD monitor unit 25 which is mounted to the camera body 11 via a hinge portion 26 formed along the ridge (border) between the rear end surface 11b and the top surface 11c. The hinge portion 26 includes a pair of support arms 27, a middle support arm 28 and a pair of pivot pins 29. The pair of support arms 27 project from the camera body 11 at positions thereon laterally apart from each other. The middle support arm 28 to which the LCD monitor unit 25 is fixed to be supported thereby is held between the pair of support arms 27. The pair of pivot pins 29 project in opposite lateral directions away from each other from opposite ends of the middle support arm 28 to be respectively inserted into pin holes of the pair of support arms 27. Due to this structure of the hinge portion 26, the pair of support arms 27 and the middle support arm 28 can rotate relative to each other about the pair of pivot pins 29. An axis X1 of the pair of pivot pins 29 extends in a lateral direction of the digital camera 10 that is orthogonal to the optical axis O. The LCD monitor unit 25 can be manually rotated about the axis X1 between a retracted position (seated position; the position shown in FIGS. 4 and 9) in which the LCD monitor unit 25 is positioned on the rear end surface 11b to sit on the optical axis O, and a maximum rotated position (the position shown by two-dot chain lines in FIG. 8) in which the LCD monitor unit 25 is fully rotated forward (clockwise as viewed in FIG. 8) about the pair of pivot pins 29 so that an edge of the LCD monitor unit 25 which is on the opposite side of the LCD monitor unit 25 from the middle support arm 28 is positioned above the hinge portion 26. When in the retracted position, the LCD monitor unit 25 lies in a plane substantially orthogonal to the optical axis O. It is desirable that the range of rotation of the LCD monitor unit 25 between the retracted position and the maximum rotated position be equal to or greater than 180 degrees. In the present embodiment of the digital camera, the range of rotation of the LCD monitor unit 25 is set at about 210 degrees.

As shown in FIG. 10, the LCD monitor unit 25 is supported by the middle support arm 28 to be rotatable on an axis X2 orthogonal to the axis X1. More specifically, a rotational pin 30 projects from a rectangular frame portion 25a of the LCD monitor unit 25 along the axis X2 thereon, while a pin-insertion hole in which the rotational pin 30 is rotatably fitted is formed on the middle support arm 28. Accordingly, the LCD monitor unit 25 is rotatable on both of the axes X1 and X2.

Although the pair of pivot pins 29 project from the middle support arm 28 to be respectively inserted into the pin holes formed on the pair of support arms 27 in the hinge portion 26 in the above illustrated embodiment of the digital camera 10, it is possible for the pair of pivot pins 29 to project from the pair of support arms 27 to be respectively inserted into pin holes formed on the middle support arm 28.

Although the rotational pin 30 projects from the rectangular frame portion 25a of the LCD monitor unit 25 to be rotatably fitted into the pin-insertion hole formed on the middle support arm 28 in the above illustrated embodiment of the digital camera 10, it is possible for the rotational pin 30 to project from the middle support arm 28 to be rotatably fitted into a pin-insertion hole formed on the rectangular frame portion 25a of the LCD monitor unit 25.

The frame portion 25a of the LCD monitor unit 25 is provided with four edge portions surrounding the rectangular LCD portion 32. The shape and size of the LCD monitor unit 25 are determined so that three of the four edge portions of the frame portion 25a, except for one of the four edge portions which is adjacent to the middle support portion 28, are substantially flush with the bottom surface 11d, the right side surface 11e and the left side surface 11f, respectively, when the LCD monitor unit 25 is in the retracted position, in which the LCD monitor unit 25 is positioned on the rear end surface 11b of the camera body 11 as shown in FIGS. 4 and 9 (see FIGS. 3 through 9).

If the LCD monitor unit 25 is rotated about the axis X1 to stand vertically as shown in FIG. 8 (from the state shown in FIG. 4 in which the LCD portion 32 faces the rear end surface 11b of the camera body 11), the LCD portion 32 faces rearwards (usually toward the user of the digital camera) so that the LCD portion 32 can be used as a monitor for showing the view through the photographing optical system or displaying stored images during playback. Although FIG. 8 shows only two states of the LCD monitor unit 25: a state of the LCD monitor unit 25 that is rotated by approximately 180 degrees from the retracted state thereof to stand vertically (the LCD monitor unit 25 shown by solid lines in FIG. 8), and a state of the LCD monitor unit 25 that is positioned in the aforementioned maximum rotated position (the position shown by two-dot chain lines in FIG. 8), the hinge portion 26 is provided with a frictional mechanism (or a click mechanism) by which the LCD monitor unit 25 can be stopped at other angular positions between the retracted position and the maximum rotated position.

The LCD portion 32 in an upright position can be made to face toward the front of the digital camera 10 by rotating the LCD monitor unit 25 about the axis X2 as shown in FIG. 10. Orientating the LCD portion 32 so as to face the front of the digital camera 10 is suitable for the case where the user photographs himself/herself (self portrait) while holding the digital camera 10. From this position, if the LCD monitor unit 25 is rotated about the axis X1 toward the retracted position to a degree that the LCD portion 32 lies in a plane substantially parallel to the top surface 11c of the camera body 11, the LCD portion 32 becomes suitable as a waist-level monitor. Additionally, from this position, if the LCD monitor unit 25 is further rotated about the axis X1 to the rear end surface 11b, the LCD portion 32 faces toward the rear of the digital camera 10 as shown in FIG. 9, not facing the rear end surface 11b. In this position shown in FIG. 9, the LCD portion 32 can be viewed without the LCD monitor unit 25 projecting (standing up) from the camera body 11. Although the vertical position of the LCD portion 32 is reversed if the LCD monitor unit 25 is rotated from the position shown in FIG. 8 to the position shown in FIG. 9, or from the position shown in FIG. 9 to the position shown in FIG. 8, the digital camera 10 is provided with a detector which detects a variation in orientation of the LCD monitor unit 25 with respect to the camera body 11, and a display image controller so that the LCD portion 32 displays an image in an upright position when viewed by the user. When the digital camera 10 is carried, it is desirable that the LCD monitor unit 25 be in the retracted position with the LCD portion 32 facing the rear end surface 11b as shown in FIG. 4 to prevent the LCD portion 32 from being damaged.

The digital camera 10 is provided on the right side surface 11e with a grip 40. The grip 40 is formed in a substantially rectangular parallelepiped similar to the camera body 11. The outer surface of the grip 40 includes opposite end surfaces (grip end surfaces) 40a and 40b, and four longitudinal side surfaces 40c, 40d, 40e and 40f which are elongated in a direction orthogonal to both of the grip end surfaces 40a and 40b. The grip end surfaces 40a and 40b are substantially parallel to each other, the longitudinal side surfaces 40c and 40d are substantially parallel to each other, and the longitudinal side surfaces 40e and 40f are substantially parallel to each other. The grip 40 is provided inside thereof with a battery chamber in which a battery pack 42 (shown by broken lines in FIG. 1) serving as a power source for driving the digital camera 10 is accommodated. The grip 40 is provided thereon with a battery chamber lid 43, an outer surface of which forms a major portion of the grip end surface 40a.

The grip 40 is pivoted (rotatable) on the camera body 11 about a pivot shaft 41. The pivot shaft 41 connects the grip 40 to the camera body 11 so that the right side surface 11e of the camera body 11 and the longitudinal side surface 40f of the grip 40 are connected to each other via the pivot shaft 41. An axis X3 of the pivot shaft 41 is substantially parallel to the axis X1 of the pair of pivot pins 29 of the hinge portion 26. The position of the pivot shaft 41 (the axis X3) is in the vicinity of the grip end surface 40b, thus being eccentrically positioned from a center of the grip 40 with respect to the lengthwise direction of the grip 40. Accordingly, the grip 40 can be rotated about the axis X3 while the free end of the grip 40 on the grip end surface 40a (the battery chamber lid 43) moves along an arc about the axis X3.

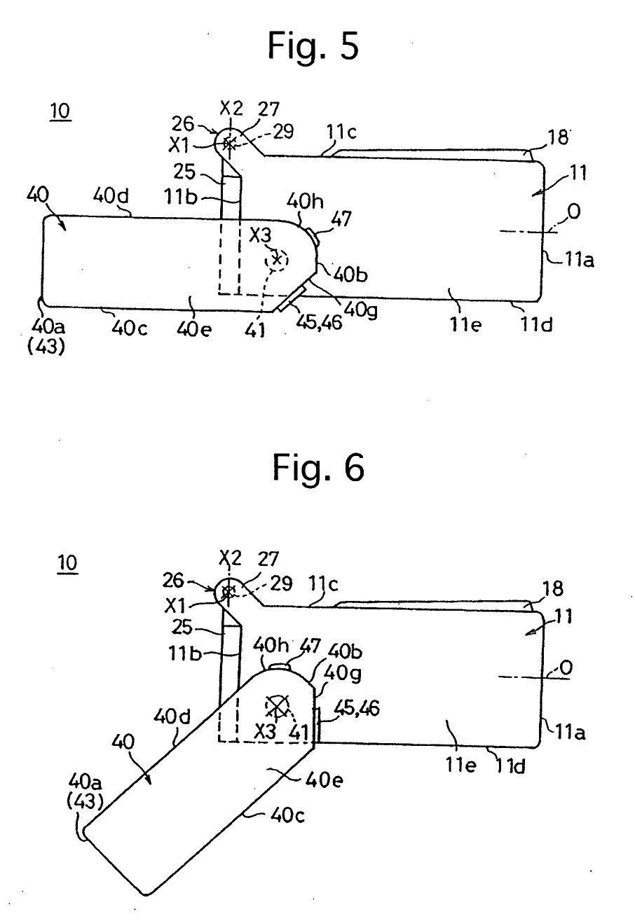

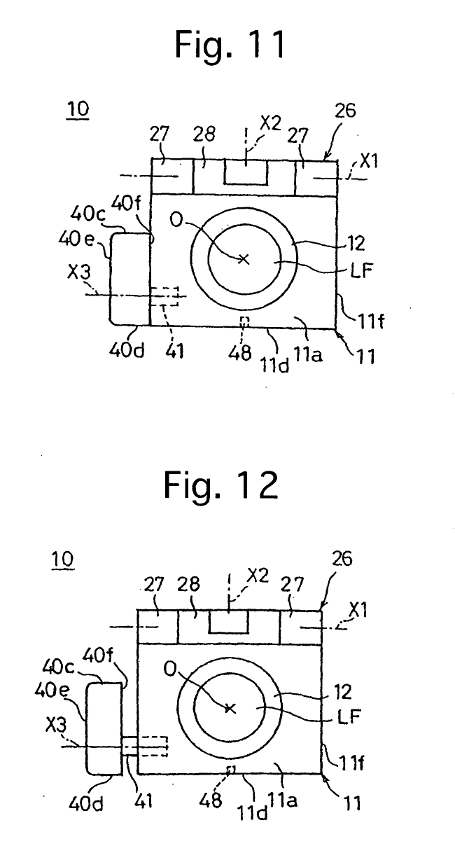

FIG. 4 shows a state in which the grip 40 is positioned at one end (retracted position) in the range of rotation of the grip 40, and FIG. 5 shows a state in which the grip 40 is at the other end (rearward-extending position) of the range of rotation of the grip 40. Although the lengthwise direction of the grip 40 is substantially parallel to the lengthwise direction of the camera body 11 at each of the retracted position and the rearward-extending position, the positions of the opposite ends 40a and 40b of the grip are reversed between the grip 40 shown in FIG. 4 and the grip 40 shown in FIG. 5. When the grip 40 is positioned in the retracted end position as shown in FIG. 4, the grip end surface 40a of the grip 40 (the battery chamber lid 43) faces toward the front of the digital camera 10, and the periphery of the grip 40 is enclosed by the periphery of the right side surface 11e as viewed from the right side of the digital camera 10. In other words, in the state shown in FIG. 4, the entire length of the grip 40 in the lengthwise direction thereof (horizontal direction as viewed in FIG. 4) is included within the length of the camera body 11 in the optical axis direction, while the entire width of the grip 40 in a direction orthogonal to the two longitudinal side surfaces 40c and 40d (in the vertical direction as viewed in FIG. 4) is included within the height of the camera body 11 in the vertical direction of the digital camera 10. Therefore, no part of the grip 40 juts outside the periphery of the camera body 11 in either the forward/rearward direction or the vertical direction of the digital camera 10. Accordingly, in the state shown in FIG. 4, the grip 40 and the camera body 11 appear as a single box unit, so that the digital camera 10 is easy to carry. Moreover, in the state shown in FIG. 4, the digital camera 10 can be placed on a floor or a desk stably because the grip 40 does not project downwards. Accordingly, the digital camera 10 is suitable for taking pictures with the camera body placed on such a flat location without the use of a tripod. When the grip 40 is in the retracted position as shown in FIG. 4, the longitudinal side surface 40d of the grip 40 (the bottom surface of the grip 40 as viewed in FIG. 4) is substantially flush with the bottom surface lid of the camera body 11 (see FIGS. 3 and 11). This structure improves the stability of the digital camera 10 in the case where the digital camera 10 is placed on a flat location such as a floor or a desk with the bottom surface 11d facing downwards.

During a photographing operation, the grip 40 is rotated clockwise from the retracted position as viewed in FIG. 4 by the user's hand so that the user can thereafter hold the digital camera 10 by holding the grip 40. The pivot shaft 41 is provided with a holding mechanism by which the grip 40 can be stopped at various angular positions between the retracted position (the position shown in FIG. 4) and the rearward-extending position (the position shown in FIG. 5). According to this holding mechanism, the angular position of the grip 40 relative to the camera body 10 can be freely selected by the user. The angular position of the LCD monitor unit 25 with respect to the camera body 11 can be freely adjusted by rotating the LCD monitor unit 25 about the axis X1 or on the axis X2 as described above. By rotating the grip 40 about the axis X3 for adjustment, independently of the above described positional adjustment of the LCD monitor unit 25, a high degree of flexibility in photographing posture can be achieved. Specifically, the structure wherein the axis of rotation (the axis X1) of the LCD monitor unit 25 and the axis of rotation (the axis X3) of the grip 40 are parallel to each other and extend in the lateral direction (horizontal direction as viewed in FIG. 3) of the digital camera 10 makes it possible to change both the vertical position and the vertical angle of the digital camera 10 at will, without loss of ability of the digital camera 10 to be held by hand and without loss of viewability of the LCD portion 32.

The pivot shaft 41 is constructed to allow the grip 40 to be positioned on and jutted away from the right side surface 11e of the camera body 11 in a direction along the axis X3 (the lateral direction of the digital camera 10) as shown in FIGS. 11 and 12. This operation of positioning the grip 40 on and jutted away from the right side surface 11e of the camera body 11 can be performed independently of the above described operation of rotating the grip 40 about the axis X3. For instance, the digital camera 10 can be made compact with the grip 40 jutting from the periphery of the camera body 11 by a minimum amount by positioning the grip 40 close to the camera body 11 when the grip 40 is positioned in the retracted position (the position shown in FIG. 4) as shown in FIG. 11. On the other hand, during a photographing operation, wherein the user holds the grip 40, the camera body 11 (specifically the right side surface 11e thereof) and the user's hand which holds the grip 40 are prevented from interfering with each other by pulling the grip 40 outward (leftward as viewed in FIG. 11) to position where the grip 40 juts away from the camera body 11 by a predetermined distance as shown in FIG. 12, which improves the ability of the grip 40 to be held by hand. Although FIG. 12 shows a state in which the lengthwise direction of the grip 40 is substantially parallel to the lengthwise direction of the camera body 11, from this state the grip 40 can be rotated about the axis X3 to be freely set at any angular position relative to the camera body 11.

As described above, the grip 40 is formed in a substantially box shape (rectangular parallelepiped), and the outer surface of the grip 40 is provided with three pairs of flat surfaces (the two grip end surfaces 40a and 40b, the two longitudinal side surfaces 40c and 40d, and the two longitudinal side surfaces 40e and 40f). The outer surface of the grip 40 is further provided in the vicinity of the grip end surface 40b with an inclined surface 40g which connects the grip end surface 40b with the longitudinal side surface 40c, and a curved surface 40h which constitutes a chamfered portion of the grip end surface 40b at the portion thereof which extends to the longitudinal side surface 40d. The inclined surface 40g, the grip end surfaces 40a and 40b, the curved surface 40h and the longitudinal side surfaces 40c and 40d constitute a surrounding surface which is substantially parallel to the axis X3 and surrounds the axis X3. The inclined surface 40g is formed as a surface non-parallel to any other external surface of the grip 40. The grip 40 is provided on the inclined surface 40g with a release button 45 and a ring-shaped zoom switch 46 which surrounds the release button 45. The curved surface 40h of the grip end surface 40b is formed to have an external positive curvature. The grip 40 is provided on the curved surface 40h with a moving-image recording button 47. The release button 45 serves as a manual operational member for photographing still images. A photometering operation and a distance measuring operation are carried out when the release button 45 is depressed halfway down, and a shutter is released when the release button 45 is fully depressed. A photographing mode and other settings are set with the above described various manual operational members as appropriate. On the other hand, the moving-image recording button 47 serves as a manual operational member for recording moving images. An operation of recording moving images commences immediately after the moving-image recording button 47 is depressed once, and thereafter stops immediately after the moving-image recording button 47 is depressed once again. The still images and moving images are processed via an image processor to be stored in a memory card as electronic image data.

As shown in FIG. 4, the inclined surface 40g is formed on the camera body 11 so as to be neither parallel nor orthogonal to a straight line S which extends in a lengthwise direction of the grip 40 between the longitudinal side surfaces 40c and 40d. It is desirable that an angle of inclination K1 of the inclined surface 40g relative to the straight line S be set at an angle between 15 to 75 degrees, more desirably between 30 to 60 degrees. The release button 45 on the inclined surface 40g faces toward the front of the digital camera 10 when the grip 40 is positioned so that the grip end surface 40a (the battery chamber lid 43) faces obliquely rearward and in a downward direction as shown in FIG. 6. In an ordinary photographing posture in which the user holds the digital camera 10 at eye-level or in the vicinity thereof, it is assumed that the grip 40 is positioned within a angular range thereof with the angle of the grip 40 shown in FIG. 6 at a central angle of the angular range. Considering the shape of a human hand, the release button 45 can be easily operated by an index finger (forefinger) if the grip 40 extends obliquely rearward, in a downward direction so that the release button 45 faces substantially toward the front of the digital camera 10 as shown in FIG. 6.

When the grip 40 is in the angular position shown in FIG. 6, the moving-image recording button 47 faces a substantially upward direction of the digital camera 10 so that the position of the moving-image recording button 47 naturally corresponds to the position of the thumb of the user's hand (right hand in the present embodiment of the digital camera) which holds the grip 40 when the index finger is put on the release button 45, due to the moving-image recording button 47 being provided on the grip end surface 40b that is adjacent to the inclined surface 40g and non-orthogonal to the inclined surface 40g. The moving-image recording button 47 is positioned on the curved surface 40h, which is chamfered so as to have an external positive curvature, and also the moving-image recording button 47 projects obliquely outwards in an inclination direction substantially opposite (symmetrical) to the axis of the release button 45 with respect to the straight line S (which extends in a lengthwise direction of the grip 40 between the longitudinal side surfaces 40c and 40d, as shown in FIG. 4). With this positional relationship between the moving-image recording button 47 and the release button 45, in which the pressing direction of the moving-image recording button 47 is inclined with respect to the pressing direction of the release button 45, the thumb of the user's hand (right hand in the present embodiment of the digital camera) holding the grip 40 can be put on the moving-image recording button 47 more naturally, which further improves the operability of the digital camera 10. It is desirable that an angle of inclination K2 of the moving-image recording button 47 relative to the straight line S be set at an angle substantially equal to the angle K1 of the inclined surface 40g (i.e., an angle of the release button 45 relative to the straight line S).

Accordingly, when the grip 40 is in the angular position shown in FIG. 6, in which the grip 40 is orientated to extend obliquely downwards, or in an angular position in the vicinity thereof, the release button 45 substantially faces an upward direction of the digital camera 10, the moving-image recording button 47 substantially faces a frontward direction of the digital camera 10, and the position of the moving-image recording button 47 naturally corresponds to the position of the thumb of the user's hand when the user holds the grip 40 with the index finger placed on the release button 45. Namely, the release button 45 and the moving-image recording button 47 are disposed on the grip 40 at positions so as to allow the user to operate the release button 45 and the moving-image recording button 47 easily and naturally when the grip 40 is rotated to be set in an operating position (ready-to-photograph position) as shown in FIG. 6.

The angle of the grip 40 relative to the camera body 11 in a ready-to-photograph state is not limited solely to those shown in FIGS. 5 and 6. For instance, when the user takes still or moving images while holding the digital camera 10 above their head, the grip 40 may be positioned at a substantially right-angle relative to the camera body 11 so that the grip end surface 40a (the battery chamber lid 43) faces vertically downwards. In this case, it is conceivable that the user holds the grip 40 with their hand while straightening the arm vertically upwards so that the arm extends in a direction substantially parallel to the lengthwise direction of the grip 40, and accordingly, the index finger and the thumb of the hand holding the grip 40 can be naturally placed on the release button 45 and the moving-image recording button 47, respectively, similar to the case shown in FIG. 6, which allows the user to operate the release button 45 and the moving-image recording button 47 comfortably.

The grip 40 is supported on the pivot shaft 41 at a position on the grip 40 which is eccentric to a center of the grip 40 in the lengthwise direction thereof to be positioned in the vicinity of the grip end surface 40b, and the release button 45 and the moving-image recording button 47 are disposed at positions on the grip 40 in radially outward directions from the pivot shaft 41 (the axis X3) in the relatively close vicinity of the pivot shaft 41. Accordingly, the positions of the release button 45 and the moving-image recording button 47 are not displaced largely with respect to the camera body 11 when the grip 40 is rotated relative to the camera body 11, which does not easily deteriorate the operability of each of the release button 45 and the moving-image recording button 47. Additionally, the release button 45 and the moving-image recording button 47 are positioned substantially on an imaginary cylindrical surface about the pivot shaft 41 (the axis X3), so that neither the distance from the pivot shaft 41 to the release button 45 nor the distance from pivot shaft 41 to the moving-image recording button 47 changes even if the grip 40 is rotated. This arrangement also facilitates the operability of the release button 45 and the moving-image recording button 47.

As can be understood from the above description, the positions of the release button 45 and the moving-image recording button 47 are determined so that the user can easily operate the release button 45 and the moving-image recording button 47 regardless of the angle of the grip 40 relative to the camera body 11.

The camera body 11 is provided on the bottom surface 11d with a tripod socket (female screw hole) 48 which is open downwards from the camera body 10 (see FIG. 4). Since the LCD monitor unit 25 and the grip 40 are supported on the rear end surface 11b and the right side surface 11e, respectively, neither the LCD monitor unit 25 nor the grip 40 overlap the bottom surface 11d of the camera body 11 even if rotated. Therefore, the tripod socket 48 is never covered by either of the LCD monitor unit 25 or the grip 40. Accordingly, even though the digital camera 10 is provided on the camera body with two independent rotatable members: the grip 40 and the LCD monitor unit 25, a photographing operation using a tripod can be carried out regardless of the of the positions of the LCD monitor unit 25 and the grip 40. Moreover, the digital camera 10 can be stably put on a floor or the like without the use of a tripod if the grip 40 is rotated to the retracted position. Namely, the digital camera 10 can be used not only in an ordinary situation in which the user takes still or moving images while holding the digital camera 10 with their hand but also in other photographing positions.

In a photographing operation, with the user holding the digital camera 10, it is generally the case that the user holds the digital camera 10 with their right hand gripping the grip 40 and with their left hand holding the camera body 11. Furthermore, it is normally the case that the palm of the left hand supports the camera body 11 from the bottom surface 11d while the thumb of the left hand is laid on the left side surface 11f, and accordingly, there is little possibility of performing an unintentional operation due to no manual operational members being provided on the bottom surface 11d. The bottom surface 11d comes in contact with the left hand by an area larger than any other external surface portions of the digital camera 10. Moreover, the photographing mode and other settings can be set without changing the user's photographing posture because the manual operational members which are frequently used during photographing, such as the flash mode select button 20, the drive mode select button 21 and the focus mode select button 22, are positioned on the left side surface 11f, on which the thumb of the left hand is placed.

During playback of recorded still and/or moving images on the LCD portion 32, it is assumed that the user holds the digital camera 10 with the fingers placed on the upper surface 11c of the camera body 11. Accordingly, manual operational members used for playback images are positioned on the top surface 11c, so that the user can easily operate these manual operational members without changing the above described photographing posture. During playback of recorded still and/or moving images, the user can hold the digital camera 10 with both hands holding the camera body 11 with the grip 40 positioned in the retracted position.

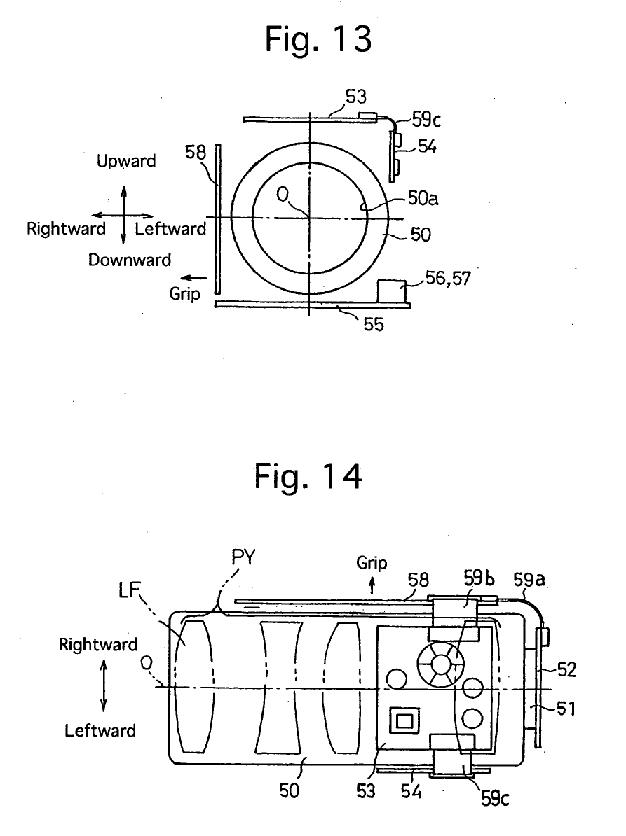

FIGS. 13 through 16 show the internal circuitry of the camera body 11, viewed from different angles. The digital camera 10 is provided in the camera body 11 with a hollow-cylindrical optical system holder 50 which holds and accommodates the photographing optical system PY of the digital camera 10. The optical system holder 50 holds the photographing optical system PY so that the axis of the optical system holder 50 extends in the optical axis direction. The optical system holder 50 is provided at the front end thereof with an aperture 50a (see FIG. 13) for holding the frontmost lens group LF therein. The digital camera 10 is provided in the camera body 11 with a CCD image sensor (image pickup device) 51 mounted to a CCD fixing plate 52. The CCD image sensor 51 is fixed at the rear end of the optical system holder 50 via the CCD fixing plate 52. Although the optical system holder 50 that serves as a holding member for holding the photographing optical system PY is formed as a single member for the purpose of making the location of the photographing optical system PY easier to recognize, the holding member does not have to be formed as a single member like the optical system holder 50.

The CCD image sensor 51 is positioned so that an imaging surface (sensitive surface) thereof lies in a focal plane of the photographing optical system PY. The CCD fixing plate 52 is positioned between the rear end of the optical system holder 50 and the rear end surface 11b of the camera body 11 to lie in a plane substantially orthogonal to the optical axis O. In addition to the CCD fixing plate 52, the digital camera 10 is provided in the camera body 11 with a first switch substrate 53, a second switch substrate 54, a jack substrate 55 and a main substrate 58. The first switch substrate 53 is formed as a flat board, and is positioned between the optical system holder 50 and the top surface 11c of the camera body 11 to be substantially parallel to the top surface 11c. The power button 13, the mode select dial 14, the playback button 15, the menu button 16 and the multi-direction button 17 are mounted to the first switch substrate 53. The second switch substrate 54 is formed as a flat board, and is positioned between the optical system holder 50 and the left side surface 11f of the camera body 11 to be substantially parallel to the left side surface 11f. The flash mode select button 20, the drive mode select button 21 and the focus mode select button 22 are mounted to the second switch substrate 54. The jack substrate 55 is formed as a flat board, and is positioned between the optical system holder 50 and the bottom surface 11d of the camera body 11 to be substantially parallel to the bottom surface 11d. A PC jack 56 for connection to a personal computer and an adapter jack 57 for power adapter (e.g., AC adapter) are mounted to the jack substrate 55. The PC jack 56 and the adapter jack 57 are positioned on the left side surface 11f to be accessible from the outside of the camera body 11 if the external connector cover 24 is opened. The main substrate 58 is formed as a flat board, and is positioned between the optical system holder 50 and the right side surface 11e of the camera body 11 to be substantially parallel to the right side surface 11e. Various components such as a microcomputer for controlling the overall operation of the digital camera 10 and a circuit for processing image data are mounted to the main substrate 58. The main substrate 58 is greater in length than the first switch substrate 53, the second switch 54 and the jack substrate 55 in the optical axis direction (forward/rearward direction of the digital camera 10). The CCD fixing plate 52 and the first switch substrate 53 are connected to the main substrate 58 via a flexible PWB 59a and a flexible PWB 59b, respectively. The second switch substrate 54 is connected to the first switch substrate 53 via a flexible PWB 59c to send signals to the main substrate 58 via the first switch substrate 53. The jack substrate 55 is connected to the main substrate 58 via a connector 55a.

As can be seen from FIGS. 13 through 16, the photographing optical system PY (the optical system holder 50) of the digital camera 10 is positioned in an internal space thereof which is surrounded by a circuit board consisting of the CCD fixing plate 52, the first switch substrate 53, the jack substrate 55 and the main substrate 58. Specifically, the photographing optical system PY that is provided in the present embodiment of the digital camera is an internal-focusing/zooming optical system, in which the focus or the focal length is altered by moving elements internally within the lens barrel as mentioned above, and accordingly, no portion of the photographing optical system PY projects forward from the front of the camera body 11, and therefore remains within the camera body 11 at all times. Additionally, the CCD fixing plate 52, the first switch substrate 53, the jack substrate 55 and the main substrate 58 are positioned in the camera body 11 to surround the photographing optical system PY. This circuit arrangement saves space for electrical components in the camera body 11, thus contributing to improvement in degree of freedom in miniaturization and design of the digital camera 10. The camera body 11 is formed as a substantially rectangular parallelepiped which is elongated along the optical axis O specifically in the illustrated embodiment of the digital camera as mentioned above, and this shape of the camera body 11 is advantageous for installing the first switch substrate 53, the second switch substrate 54, the jack substrate 55 and the main substrate 58 along an inner surface of the camera body 11 which extends in the lengthwise direction of the camera body 11.

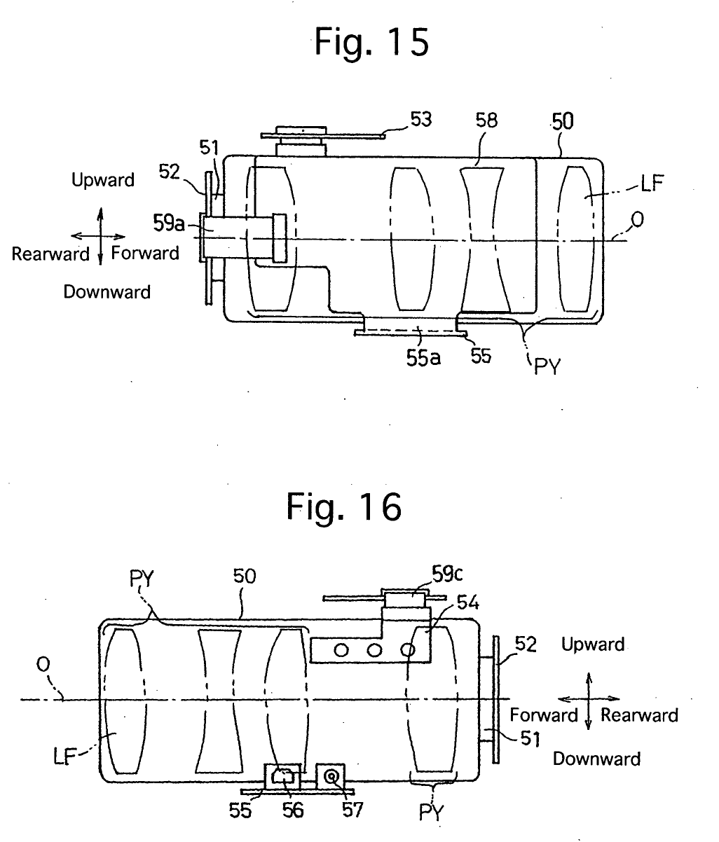

In the present embodiment of the digital camera, the rotatable grip 40 is mounted to the right side surface 11e of the camera body 11. It is desirable that no elements such as operational switches or terminals (jacks) be provided on a surface of the camera body to which a rotatable member such as the grip 40 is mounted in order to prevent the rotatable member from interfering with such elements. Accordingly, the first switch substrate 53 and the second switch substrate 54, which include switch contacts, and the jack substrate 55, which includes electrical terminals, are installed along three inner surfaces of the camera body 11 which correspond to the top surface 11c, the bottom surface 11d and the left side surface 11f, respectively, and no substrate is installed along an inner surface of the camera body 11 which corresponds to the right side surface 11e. By taking advantage of this structure in which no elements such as switches or terminals are installed (cannot be installed) to the right side surface 11e of the camera body 11, the main substrate 58, which does not have to be connected to any external parts or devices, is installed in the immediate area of the inner surface of the camera body 11 which corresponds to the right side surface 11e. As can be seen from FIGS. 14 and 15, the internal space of the camera body 11 on the right side surface 11e is exclusively assigned to the installation of the main substrate 58, which makes it possible to adopt the large main substrate 58 that is shaped to have a length close to the length of the optical system holder 50 in the optical axis direction.

Likewise, no elements such as switches or terminals are installed on the rear end surface 11b of the camera body 11, which supports the movable LCD monitor unit 25 (a movable member like the grip 40), while the CCD fixing plate 52, which does not have to be connected to any external parts or devices similar to the main substrate 58, is installed in the immediate area of an inner surface of the camera body 11 which corresponds to the rear end surface 11b. In terms of the efficiency of saving space and simplifying the circuitry, it is desirable that the CCD fixing plate 52, on which the CCD image sensor 51 is mounted, be positioned in the internal space of the camera body 11 in the vicinity of the rear end surface 11b since the internal space of the camera body 11 in the vicinity of the rear end surface 11b is adjacent to the rear end of the photographing optical system PY.

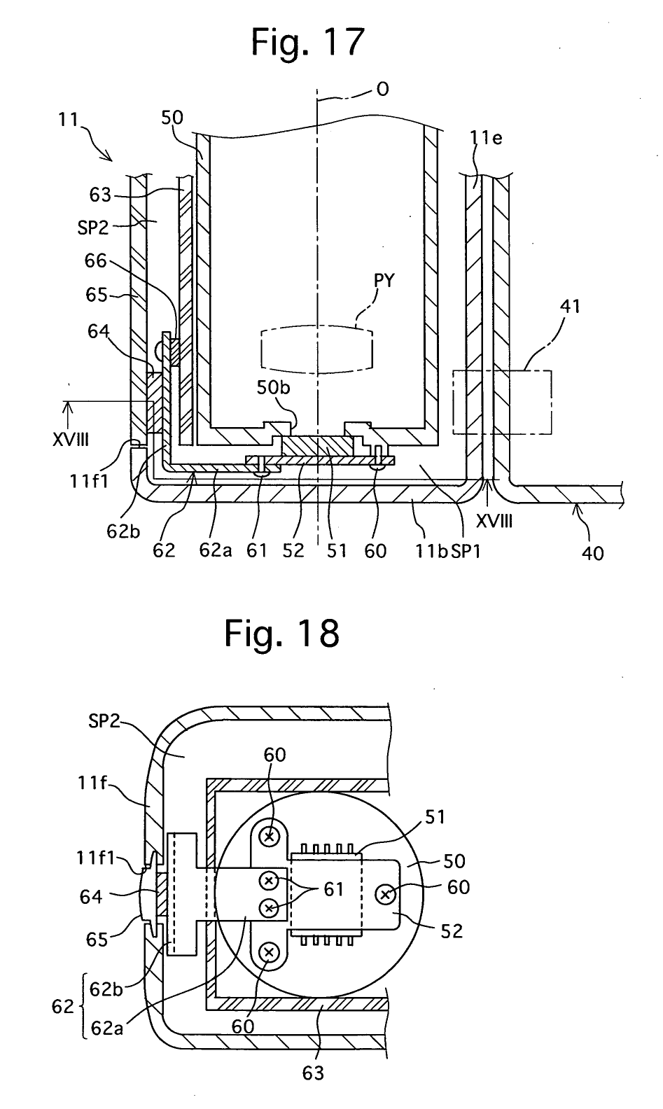

FIGS. 17 and 18 show a heat radiating structure of the digital camera 10 in the vicinity of the CCD image sensor 51. As mentioned above, the photographing optical system PY is held and accommodated by the optical system holder 50, and the top surface 11c, the bottom surface 11d, the right side surface 11e and the left side surface 11f of the camera body 11 are positioned outside of the photographing optical system PY to surround the photographing optical system PY. The rear end surface 11b of the camera body 11 is positioned to face the rear end of the optical system holder 50 in the optical axis direction. The digital camera 10 is provided therein, between an exterior part of the camera body 11 (the top surface 11c, the bottom surface 11d, the right side surface 11e and the left side surface 11f) and the optical system holder 50 in radial directions of the optical axis O, with an intermediate heat-insulation frame 63 which surrounds the left, top and bottom sides of the optical system holder 50. The intermediate heat-insulation frame 63 serves as a fixing member for fixing the optical system holder 50 to the camera body 11.

The CCD image sensor 51 that is mounted on the CCD fixing plate 52 is positioned to face the photographing optical system PY through a rear end opening 50b formed at the rear end of the optical system holder 50. The CCD fixing plate 52 is fixed to the rear end of the optical system holder 50 by two set screws 60. A heat radiating plate 62 is fixed to the CCD fixing plate 52 by another two set screws 61. The heat radiating plate 62 has an L-shaped cross section as shown in FIG. 17 and is composed of a heat-transfer plate portion 62a and a heat radiating plate portion 62b. The heat-transfer plate portion 62a extends in a direction approaching the left side surface 11f in a first space SP1 formed between the rear end surface 11b and the rear end of the optical system holder 50, while the heat radiating plate portion 62b is bent relative to the heat-transfer plate portion 62a at a substantially right angle to extend toward the front of the digital camera 10 from the left end of the heat-transfer plate portion 62a in a second space SP2 formed between the left side surface 11f and the intermediate heat-insulation frame 63. The heat radiating plate portion 62b is formed to have a wider width than the heat-transfer plate portion 62a (see FIG. 18). A portion of the heat radiating plate portion 62b in the vicinity of the front end thereof is supported by the intermediate heat-insulation frame 63 via a heat-insulation spacer 66.

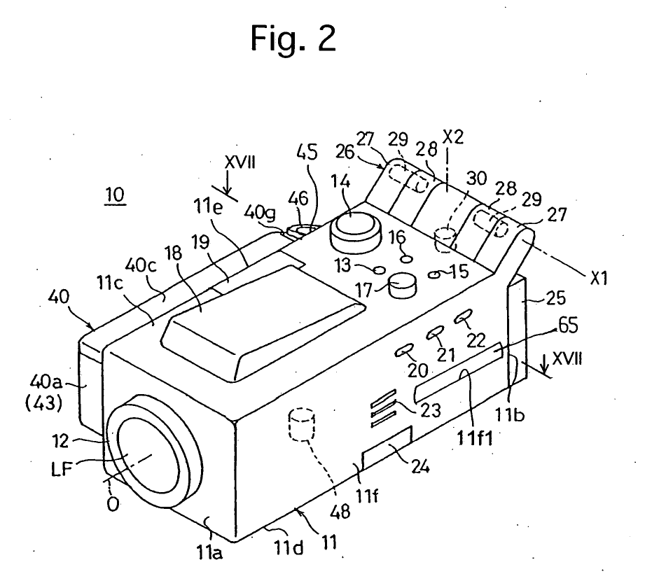

The camera body 11 is provided with a radiating elongated hole (through-hole) 11f1, which extends through the left side surface 11f so as to communicatively connect the second space SP2 with the outside of the digital camera 10, and a molding (external radiating member) 65 (see FIG. 2) is fitted into the elongated hole 11f1. The molding 65 forms a part of the exterior of the digital camera 10, and is elongated in the lengthwise direction of the camera body 11 to have a predetermined length in the same direction. The molding 65 and the heat radiating plate 62 are connected to each other via an elastic heat transfer member 64.

In the above described structure in the vicinity of the CCD image sensor 51, the camera body 11, the intermediate heat-insulation frame 63 and the heat-insulation spacer 66 are each made of a material having a low thermal conductivity such as a synthetic resin. On the other hand, the set screws 60, the set screws 61, the CCD fixing plate 52, the heat radiating plate 62, the elastic heat transfer member 64 and the molding 65 are each made of a material having a high thermal conductivity. Specifically, each of the set screws 60 and 61 is desirably made of metal such as copper, the CCD fixing plate 52 and the heat radiating plate 62 are desirably made of metal such as copper or aluminum, and the elastic heat transfer member 64 is desirably made of a heat conduction rubber or a heat conduction silicon. The molding 65 is made of a material having a higher thermal conductivity than the thermal conductivity of at least the camera body 11. It is desirable that the entirety of the molding 65 be made of metal or that at least the outer surface of the molding 65 be plated with metal.

According to the above described heat radiating structure of the digital camera 10, the heat generated by the CCD image sensor 51 is dissipated into the atmosphere outside of the camera body 11 via the CCD fixing plate 52, the heat radiating plate 62, the elastic heat transfer member 64 and the molding 65 in that order. In addition, it is difficult for heat to transfer from the heat radiating plate 62 to the optical system holder 50 since the intermediate heat-insulation frame 63 that has a low thermal conductivity is positioned between the heat radiating plate portion 62b of the heat radiating plate 62 and the optical system holder 50. Specifically, the heat generated by the CCD image sensor 51 can be prevented from being transferred from the heat radiating plate 62 to the intermediate heat-insulation frame 63 and even to the optical system holder 50 that is positioned inside of the intermediate heat-insulation frame 63 with an improved stability of support of the heat radiating plate 62 because the heat radiating plate portion 62b of the heat radiating plate 62 is supported by the intermediate heat-insulation frame 63 via the heat-insulation spacer 66 that has a low thermal conductivity.

It is possible that an additional heat insulator (not shown) be installed between the heat radiating plate 62 and the intermediate heat-insulation frame 63 or between the intermediate heat-insulation frame 63 and the optical system holder 50 to achieve a further improvement in thermal insulation effect to the optical system holder 50 and the photographing optical system PY that is positioned inside the optical system holder 50.

On the other hand, the elastic heat transfer member 64 contacts an outer surface of the heat radiating plate portion 62b of the heat radiating plate 62 to actively dissipate heat to the molding 65 via the elastic heat transfer member 64. The molding 65 has a high heat radiation efficiently because the molding 65 is exposed to the exterior of the digital camera 10 and because at least the outer surface of the molding 65 is made of metal. Moreover, the heat radiation efficiency is further enhanced by forming the radiating elongated hole 11f1, that communicatively connects the inside of the camera body 11 to the outside thereof, as a heat radiating path to an external radiating member such as the molding 65 with the heat radiating plate 62 and the molding 65 being connected to each other with a minimum distance therebetween. The heat radiation efficiency of the molding 65 is not prevented by the grip 40 because the molding 65 is mounted to the left side surface 11f that is disposed on the opposite side of the camera body 11 from the right side surface 11e.

The degree of intimate contact of the elastic heat transfer member 64 with respect to each of the heat radiating plate 62 and the molding 65 is high because the elastic heat transfer member 64 is in elastic contact with each of the heat radiating plate 62 and the molding 65, which achieves a further improvement of the heat conductive efficiency and the heat radiation efficiency.

In the present embodiment of the digital camera 10, the camera body 11 is formed as a tubular body which is elongated in the optical axis direction, while the distance between the optical system holder 50 and an exterior part of the camera body 11 (the top surface 11c, the bottom surface 11d, the right side surface 11e and the left side surface 11f) is small. Therefore, the heat radiating path from the CCD image sensor 51 to the outside of the digital camera 10 can be shortened, which contributes to an improvement in the heat radiation efficiency. Accordingly, it is desirable that the heat be dissipated to the left side surface 11f rather than the rear end surface 11b because the LCD monitor unit 25 is supported on the rear end surface 11b though the rear end surface 11b is closer to the CCD image sensor 51 than the left side surface 11f.

Due to the above described heat radiating structure of the digital camera 10, in the present embodiment of the digital camera 10, the heat generated by the CCD image sensor 51 can be efficiently dissipated into the atmosphere outside the digital camera 10, and can also be made difficult to transfer to the photographing optical system PY (the optical system holder 50). Therefore, image data which is output from the CCD image sensor 51 can be prevented from including noise caused by the heat generated by the CCD image sensor 51. Additionally, the optical accuracy of a photographing unit (the photographing optical system PY and the optical system holder 50) can be efficiently prevented from deteriorating.

Obvious changes may be made in the specific embodiment of the present invention described herein, such modifications being within the spirit and scope of the invention claimed. It is indicated that all matter contained herein is illustrative and does not limit the scope of the present invention.

1. A heat radiating structure of a digital camera, comprising:
an optical system holder which accommodates and holds an image-forming optical system;
an image pickup device supported by said optical system holder at a position on a focal plane of said image-forming optical system;
an outer casing which constitutes an external body of said digital camera which surrounds said optical system holder, said outer casing having a through-hole which communicatively connects the inside of said outer casing with the outside of said outer casing;
an external radiating member installed in said through-hole, said external radiating member being made of a material having a thermal conductivity higher than a thermal conductivity of a material of said outer casing;
a heat radiating plate, one end of which is connected to said image pickup device and another end of which extends into a space between said external radiating member and said optical system holder; and
a heat transfer member via which said heat radiating plate and said external radiating member are connected to each other to transfer heat from said heat radiating plate to said external radiating member.

2. The heat radiating structure according to claim 1, wherein said heat transfer member is made of an elastic material having a high thermal conductivity.

3. The heat radiating structure according to claim 1, further comprising an intermediate heat-insulation frame positioned between said optical system holder and said outer casing,
wherein said heat radiating plate and said intermediate heat-insulation frame are connected to each other via a heat-insulation spacer.

4. The heat radiating structure according to claim 1, wherein said outer casing comprises a plurality of flat portions positioned to surround an optical axis of said image-forming optical system,
wherein said digital camera comprises a rotatable grip mounted to one of said plurality of flat portions to be rotatable relative said one of said plurality of flat portions, and
wherein said through-hole, in which said external radiating member is installed, is formed on another of said plurality of flat portions.

5. The heat radiating structure according to claim 1, wherein said heat radiating plate is made of metal.

6. The heat radiating structure according to claim 1, wherein said heat radiating plate comprises:
a first plate portion including said one end of said heat radiating plate; and
a second plate portion including said another end of said heat radiating plate, said second plate portion extending toward the front of said digital camera from said first plate portion in said space between said external radiating member and said optical system holder.

7. The heat radiating structure according to claim 1, wherein said through-hole is formed as an elongated hole and said external radiating member is correspondingly formed as an elongated member to be fitted in said elongated hole.

8. The heat radiating structure according to claim 1, wherein at least a part of said external radiating member is made of metal.

9. A heat radiating structure of a digital camera, comprising:
an optical system holder which holds an image-forming optical system, an image pickup device being supported by said optical system holder at a rear end thereof in an optical axis direction;
a tubular outer casing which constitutes an external body of said digital camera, said tubular outer casing including a surrounding portion which surrounds said optical system holder, and a rear end portion positioned to face a rear portion of said image pickup device;
an intermediate heat-insulation frame provided inside said tubular outer casing between said surrounding portion and said optical system holder;
a heat radiating plate, one end of which is connected to said image pickup device, said heat radiating plate extending from a first space between said rear end portion of said tubular outer casing and said image pickup device to a second space between said surrounding portion and said intermediate heat-insulation frame;
an external radiating member fixed to said surrounding portion to extend therethrough to face said heat radiating plate and to be exposed to an external portion of said digital camera, said external radiating member being made of a material having a thermal conductivity higher than a thermal conductivity of a material of said tubular outer casing; and
a heat transfer member via which said heat radiating plate and said external radiating member are connected to each other to transfer heat from said heat radiating plate to said external radiating member.
